(19) United States
(12) Patent Application Publication
(10) Pub. No.: US 2022/0215320 A1
(43) Pub. Date: Jul. 7, 2022

(54) PROCESS DATA PROCESSING METHOD AND APPARATUS, STORAGE MEDIUM, AND ELECTRONIC EQUIPMENT

(71) Applicant: CHANGXIN MEMORY TECHNOLOGIES, INC., Hefei City (CN)

(72) Inventors: Daofeng ZHU, Hefei City (CN); Sheng-Hua Su, Hefei City (CN); MingHung HSIEH, Hefei City (CN)

(21) Appl. No.: 17/652,345

(22) Filed: Feb. 24, 2022

Related U.S. Application Data
(63) Continuation of application No. PCT/CN2021/113346, filed on Aug. 18, 2021.

(30) Foreign Application Priority Data
Jan. 4, 2021 (CN) 202110004199.5

(51) Int. Cl. G06Q 10/06; G06Q 50/04

(52) U.S. Cl. CPC G06Q 10/06395; G06Q 50/04

(57) ABSTRACT

A method for processing process data, a process data processing apparatus, a computer-readable storage medium, and an electronic equipment are provided, belonging to the field of manufacturing technology. The method includes: acquiring modified data for process data; checking whether the modified data is compliant according to the fields of the modified data; and generating a modification record according to the modified data when it is determined that the modified data is compliant.

### CROSS-REFERENCE TO RELATED APPLICATIONS

This is a continuation of International Application No. PCT/CN2021/113346, filed on Aug. 18, 2021, which claims the priority to Chinese Patent Application 202110004199.5, titled “PROCESS DATA PROCESSING METHOD AND APPARATUS, STORAGE MEDIUM, AND ELECTRONIC EQUIPMENT” and filed on Jan. 4, 2021. The entire contents of International Application No. PCT/CN2021/113346 and Chinese Patent Application 202110004199.5 are incorporated herein by reference.

### TECHNICAL FIELD

The present disclosure relates to the field of manufacturing technology, and in particular to, a method for processing process data, a process data processing apparatus, a computer-readable storage medium, and an electronic equipment.

### BACKGROUND

In the technical fields of semiconductors and integrated circuits, the manufacture of electronic components often requires a variety of machine equipment. For example, during the manufacturing of electronic components of semiconductors, a variety of different processing equipment such as thin film equipment, yellow light equipment, etching equipment and chemical mechanical polishing equipment, are used to gradually define patterns of the components. Meanwhile, in order to make the product characteristics of the electronic components meet the specification requirements, operating personnel need to set up strict cleanliness standards for the working environment, and strict specification requirements are also set up for the processing equipment. Therefore, during the operation, whether the working environment and the processing equipment meet the production standards need to be frequently checked.

In actual production, data such as equipment and recipes are the key to each production step, so the efficiency of modifying such data is related to the progress of production and testing. The complete production data of a component includes a large number of data tables and fields, and the modification position needs to be manually screened and modified. However, due to the relatively large data volume, manual inspections are prone to missing modification and wrong modification, which leads to relatively low inspection efficiency of process data and consumes a lot of human resources.

It should be noted that the information disclosed in the background section above is only used to enhance the understanding of the background of the present disclosure, and therefore may include information that does not constitute the prior art known to those of ordinary skill in the art.

### SUMMARY

Other characteristics and advantages of the embodiments of the present disclosure will become apparent through the following detailed description, or are partly learned through the practice of the present disclosure.

According to the first aspect of the embodiments of the present disclosure, a method for processing process data is provided, the method including: acquiring modified data for process data; checking whether the modified data is compliant according to the fields of the modified data; and generating a modification record according to the modified data when it is determined that the modified data is compliant.

According to the second aspect of the embodiments of the present disclosure, a process data processing apparatus is provided, the apparatus including: one or more processors; and a storage apparatus, configured to store one or more programs, wherein the one or more programs, when executed by the one or more processors, cause the one or more processors to execute operations of: acquiring modified data for process data; checking whether the modified data is compliant according to fields of the modified data; and a generating a modification record according to the modified data when it is determined that the modified data is compliant.

According to the third aspect of the embodiments of the present disclosure, a computer-readable storage medium is provided, storing a computer program thereon, wherein when the computer program is executed by a processor, any of the above methods for processing process data is implemented.

It should be understood that the above general description and the following detailed description are only exemplary and explanatory, and cannot limit the present disclosure.

### BRIEF DESCRIPTION OF THE DRAWINGS

The accompanying drawings herein are incorporated into the specification and constitute a part of the specification, show embodiments consistent with the present disclosure, and are used to explain the principle of the present disclosure together with the specification. Apparently, the drawings described below are only some of the drawings of the present disclosure, and other drawings may also be obtained by those of ordinary skill in the art according to these drawings without any creative efforts.

FIG. 1 shows a flowchart of a method for processing process data in an exemplary embodiment;

FIG. 2 shows a schematic structure diagram of data storage in an exemplary embodiment;

FIG. 3 shows a schematic diagram of a method for acquiring modified data in an exemplary embodiment;

FIG. 4 shows a schematic diagram of a method for checking the modified data in an exemplary embodiment;

FIG. 5 shows a schematic diagram of a method for controlling an operation step in an exemplary embodiment;

FIG. 6 shows a schematic diagram of a method for comparing modification records in an exemplary embodiment;

FIG. 7 shows a flowchart of a method for rapid error detection of process data in an exemplary embodiment;

FIG. 8 shows a flowchart of a current process data comparison method in an exemplary embodiment;

FIG. 9 shows a structural block diagram of a process data processing apparatus in an exemplary embodiment;

FIG. 10 shows a computer-readable storage medium for implementing the above method in an exemplary embodiment;

FIG. 11 shows an electronic equipment for implementing the above method in an exemplary embodiment.

### DETAILED DESCRIPTION

Example embodiments are now described more comprehensively with reference to the accompanying drawings. However, the example embodiments can be implemented in various forms, and should not be construed as being limited to the examples set forth herein; on the contrary, the provision of these embodiments makes the present disclosure more comprehensive and complete, and fully conveys the concept of the example embodiments to those skilled in the art. The features, structures or characteristics described may be combined in one or more embodiments in any suitable way.

In view of the foregoing various problems, an exemplary embodiment of the present disclosure first provides a method for processing process data, and the method can be applied to a process data management system to manage and check process data.

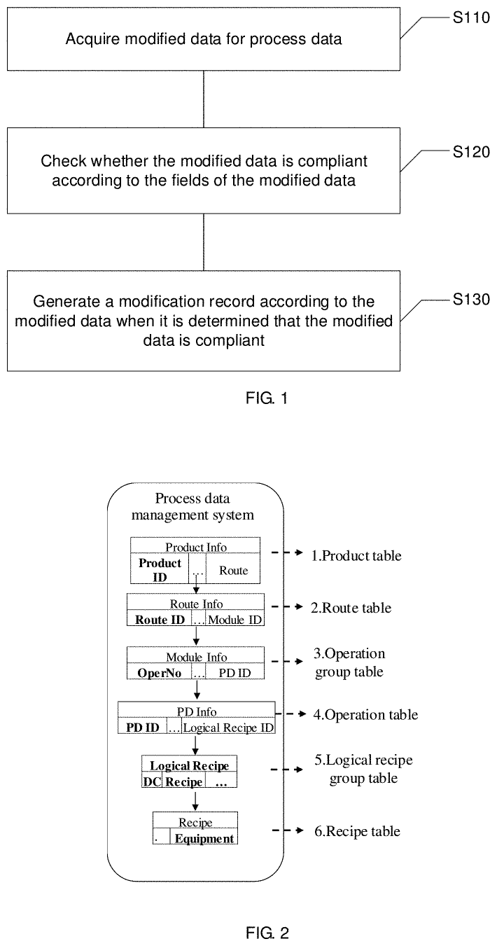

FIG. 1 shows a process of this exemplary embodiment, which may include the following steps S110 to S130:

Step S110, modified data for process data is acquired.

The process data refers to data used and generated in process design. In view of the nature of data, the process data generally may include static process data and dynamic process data. The static process data is generally composed of processing material data, processing data, equipment data, standard process specification data, component data, etc. The dynamic process data generally refers to relevant information generated during process planning, and the dynamic process data is generally composed of a large amount of intermediate process data, part graphic data, process graphic data, final process specifications, etc. The modified data may be data modified from the process data by a user, and generally may include part or all of the process data. In addition, according to the content and type of the process data, the above process data and modified data may be stored in a specific database or the above process data management system according to the hierarchical structure shown in FIG. 2.

Because the manufacturing of components requires a variety of machine equipment, a large amount of process data will be generated during the manufacturing of a component. For example, in the process data of some components, a large number of data tables are often generated, and each data table includes many fields. If the data is manually filtered and modified, a lot of time will be taken. Therefore, by obtaining the modified data for the process data, the data modified by the user can be quickly filtered out of the process data, thereby improving the search efficiency of the modified data.

After the process data is generated, the user can edit it. Therefore, in an optional embodiment, the modified data may be obtained by acquiring the process data edited by the user, specifically, in the following way:

providing editable data of the process data in response to a user's query request for the process data; and

receiving the modified data for the editable data.

The editable data may be process data that can be edited, such as modified, added, or deleted. The editable data may be identical to the process data or different from the process data. For example, the editable data may be part of the process data, or data that has a substantial impact on the process, such as equipment data and component data.

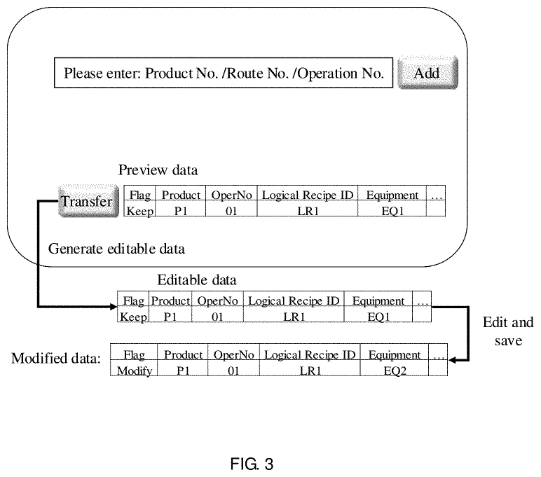

When the process data needs to be modified, the user may send a query request for acquiring the editable data of the process data. For example, in the interface of the process data management system as shown in FIG. 3, the user may input data such as product number, route number and operation step, and then select the “Add” option, then reports in the database of the system may be associatively queried to obtain a corresponding logical recipe group and fields therein, the corresponding logical recipe group and fields therein are transferred to generate the editable data for the user to modify. For example, the user may add or delete data records, or modify a specific data record. After the user confirms that the modification is completed, as shown in FIG. 3, the editable data after the modification may be saved as modified data, and the modified data is stored in the process data management system.

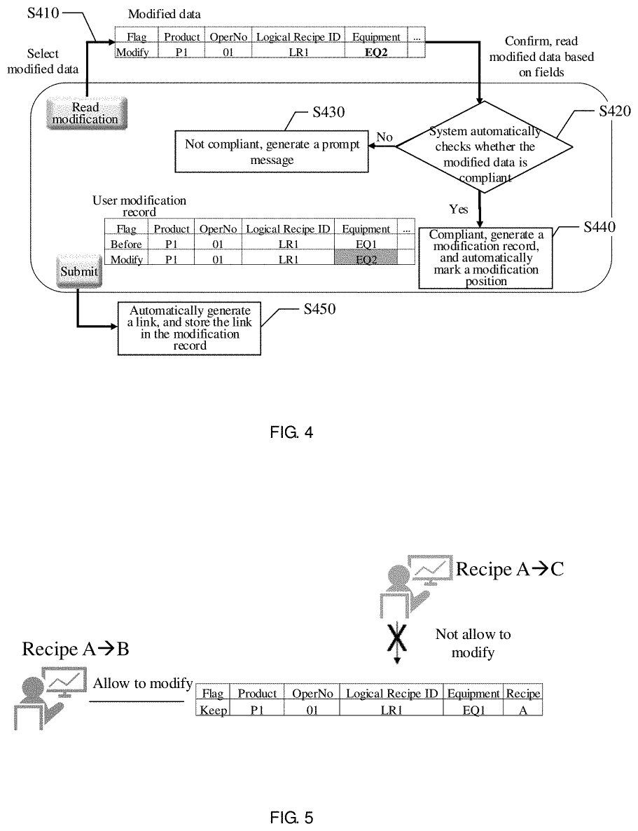

In an optional embodiment, the receiving modified data for editable data may be completed by receiving the modified data in response to an editing completion operation on the editable data. For example, after the user completes the modification of the editable data, as shown in step S410 in FIG. 4, the modified data may be stored in the process data management system by selecting the option “Read modified data”.

In another optional embodiment, the receiving modified data for editable data may be completed by receiving the modified data in response to an editing operation on the editable data. Specifically, when the user operates or modifies the editable data, the modified data obtained by the user modifying the editable data is received in real time; or when the user operates or modifies the editable data, user's modification information about the editable data may be received in real time, and the editable data is synchronously processed according to the modification information to obtain modified data.

Further, when the editable data is acquired, in order to remove the data of the fields that are not affected in the process data so that the user can quickly determine the data that needs to be modified in the editable data, the above editable data may include only preset fields of the process data in an optional embodiment. The preset fields may be used to indicate the attributes of one or more data records, including any one or more of equipment group, equipment, recipe, recipe version, available reaction chamber for the recipe, unavailable reaction chamber, whether the operation equipment selects different recipe identification according to different reaction chambers, sampling policy, number of samples, monitor product identification, whether to wait for complete measurement of the monitor product, probe fixture group, whether recipe parameter identification is set at an operation step, etc. Table 1 below shows an example of a type of field data in this exemplary embodiment:

TABLE 1

| | |
|---|---|
| Field | Explanation |
| Flag | Identification |
| Product ID | Product number |
| Product Vers | Product version |
| 1. Main_PD_ID | Route number |
| 2. Vers | Route version |
| 3. OPER_NO | Operation number |
| 4. Module_PD_ID | Operation group number |
| 8. PD_Type | Operation type |
| 16. Logical_Recipe_ID | Logical recipe group |
| 17. Vers | Logical recipe group version |
| 18. Department_ID | Operation department |
| 19. Name Space | Equipment group |
| 20. Recipe_ID | Recipe |
| 21. Vers | Recipe version |
| 22. Equipment | Equipment |
| 23. Available | Equipment, reaction chamber used in |
| | the recipe |
| 24. Not_Use | Equipment, reaction chamber not |
| | used in recipe |
| 25. Down | Unavailable reaction chamber for the |
| | equipment |
| 26. Multiple_Chamber_Flag | Whether the operation equipment |
| | chooses different recipe flags |
| | according to different reaction |
| | chambers |
| 34. PD_DCD | Value collection definition ID |
| | (Identification) for operation step |
| 35. DCS_Flag | Define different value collection |
| | standards according to priority |
| 36. DCS_Value | Priority value |
| 37. Module_DCS | Value collection standard definition |
| | ID for measurement operation step |
| 39. PD_DCS | Value collection standard definition |
| | ID for process operation step |
| 40. LR_Sampling_Policy_Name | Define sampling policy |
| 41. LR_Sampling_Attribute | Define number of samples |
| 42. LR_Monitor_PROD_ID | Monitor product ID |
| 43. LR_Monitor_Hold | Whether to wait for complete |
| | measurement of monitor product |
| 57. LR_Sampling_Spec_ID | NA (not used) |
| 76. Fixture_Group_ID | Probe fixture group |
| 81. Recipe Parameter Flag | Whether the operation step is set |
| | with a recipe parameter flag |

In addition, in order to facilitate the user to acquire the required process data and improve user's operating efficiency, in an optional embodiment, when the process data is acquired, preview data of the process data may be displayed in response to user's query request for the process data. The preview data may be part of the process data, for example, it may be data of key fields in the process data. For example, in the interface shown in FIG. 3, when user's operation to select an “Add” option is received, the queried preview data of the process data may be displayed. As can be seen from the figure, the preview data may include key fields such as Flag, Product, OperNo, Logical Recipe ID and Equipment, and some values corresponding to the key fields.

Step S120, whether the modified data is compliant is checked according to the fields of the modified data.

In order to facilitate the check of the modified data, whether each field in the modified data or the data in the modified field is compliant may be checked according to the fields of the modified data to determine whether the modified data is compliant. For example, whether the data records in the modified data are repeated is checked in sequence, and whether each field includes special characters that are not allowed, such as spaces and underlines.

Considering that the data of some fields may have certain value range in the process data, for example, the equipment code entered in the equipment field must be the code of the actual equipment, and cannot be the equipment code that does not exist in the actual production. Therefore, in an optional embodiment, step S120 may be implemented in the following way:

determining the fields of the modified data;

obtaining a preset modification rule for each field; and

checking whether the corresponding data in the fields of the modified data is compliant under the preset modification rule.

The preset modification rule may be pre-configured according to the actual value requirements of the corresponding field. For example, the preset modification rule may include any one or more of the following: (1) a value allowed to be set in the field, (2) data in the field being in a preset format, such as numeric value and character string, (3) no repeated data in the field, (4) no empty value in the field, (5) no special characters in the field, such as spaces and underlines, (6) data in the field being a preset value, such as “Yes” or “No”, or any one of the existing parameter values, (7) an associated setting rule for data in two fields at least, for example, when the value of a certain field is a preset value, the value that can be set in the data in one or more associated fields, and (8) whether the data in the field is consistent with the pre-stored data, wherein the pre-stored data may be standard process data used on the production line at the current moment. For example, when the modified data includes the data in one or more specific field, standard process data pre-stored in the system may be obtained while the modified data is checked for compliance, and the data of the specific fields in the modified data is compared with the data of the corresponding fields in the standard process data to determine whether the data of the specific fields in the modified data is consistent with the data of the corresponding fields in the standard process data.

Fields of the modified data, such as all fields in the modified data, or fields in the modified data that have been modified by the user, are determined, preset modification rules for the determined fields are obtained, and whether the data in the corresponding fields in the modified data is compliant is checked by using the preset modification rules. For example, referring to step S420 in FIG. 4, whether the data in each field in the modified data meets the preset modification rule can be automatically checked, and if the data in each field meets the corresponding preset modification rule, it is determined that the modified data is compliant, or else if any data in each field does not meet the corresponding preset modification rule, it is determined that the modified data is not compliant. Specifically, the system may read data of each field of the modified data, and check whether the data corresponding to each field meets the above preset modification rule during the reading. For example, taking an equipment field as an example, the system may read data of the equipment field, and compare the data with an equipment information table pre-stored in a database, to confirm whether the equipment ID in the equipment field is an established equipment code.

When it is checked that the modified data is not compliant, in order to remind the user to correct the data in time, in an optional embodiment, when whether the modified data is compliant is checked, and when the modified data is not compliant, a prompt message about the modified data is generated by the method shown by step S430 in FIG. 4. The prompt message may be a message pop-up window, may include information that the modified data is not compliant, and may also include specific data records that are not compliant in the modified data. For example, when it is determined that the equipment ID is not an established equipment code, a prompt message “the currently entered equipment ID does not exist” is generated.

When the user modifies the editable data, modified data may also be obtained by acquiring the modified data in real time or receiving modification information of the editable data. Therefore, in an optional embodiment, checking whether the modified data is compliant can be implemented by checking in real time whether the acquired modified data is compliant when the user modifies the editable data.

In addition, in order to prevent multiple users from editing the same data of the editable data at the same time to cause data modification errors, in an optional embodiment, it can be checked whether the current user has completed the operation or modification on the corresponding data in the editable data; when it is determined that the current user is modifying the corresponding data, a data position in the corresponding process data or editable data is locked to ensure that only the current user is allowed to modify the data in the data position at the current moment; when it is determined that the current user finishes the modification, the process data and the data position in the editable data are set to a modification allowing state, so that other users can modify the above process data or the data at the corresponding position in the corresponding editable data. For example, referring to FIG. 5, when user A is operating or modifying the data in the Recipe field of the editable data, for user A, the process data and the data in the Recipe field of the corresponding editable data are in a modification allowing state; for user B, the process data and the data in the Recipe field of the editable data are in a locked state, such as a state of allowing to view but forbidding modification; if the user B needs to modify the data in the Recipe field of the editable data, the user B needs to wait for the end of the modification by user A; while user B is waiting to modify the data in the Recipe field, the process data management system can cyclically detect the modification state of the Recipe field, and when the detected modification state of the data is any one of “Return”, “End” and “Cancel”, the locked state of the Recipe field can be released and set to the modification allowing state, and the user B can modify the Recipe field.

Step S130, a modification record is generated according to the modified data when it is determined that the modified data is compliant.

The modification record is record information that the user modifies the modified data, and may include time, modification user, modification position, data before modification, data after modification, etc.

When it is determined that the modified data is compliant, in order to record user's modification information, a corresponding modification record may be generated according to the modified data.

In order to facilitate the determination of the modification position in the modified data, in an optional embodiment, when the modification record is generated according to the modified data, the modification position corresponding to the modified data may be marked in the modification record. Specifically, when the modification position is marked, the data at the modification position may be displayed in a special color or font style, and may also be marked by adding a text box, an underline, etc. For example, referring to FIG. 4, the modification record may be generated through step S440, and the modified data of the corresponding field in the modification record may be marked in a different color from other positions.

In an optional embodiment, when the modification record is generated according to the modified data, a link for the modification record may also be generated, and when user's operation to select the link is received, the modification record may be provided in response to the operation. For example, continuing to refer to FIG. 4, the link of the modification record may be automatically generated through step S450 and stored in the modification record. When user's operation to select the link is received, the modification record is directly displayed, or the modification record is transferred to the local for the user to view.

Further, after the modification record is generated, in order to determine whether the modified data meets the requirements of industrial manufacturing, the user or data management personnel such as form review personnel can compare the modified data with the current process data to avoid the modified data that does not match the current process data. In an optional embodiment, the modification record may be checked in the following way:

acquiring current process data, and comparing the current process data with the modification record and obtaining a comparison result.

The current process data may be standard process data used on the production line at the current moment. Generally, the data can be formulated by a processing engineer and stored in the above-mentioned process data management system, or stored in a separate data management system, such as a standard specification management system.

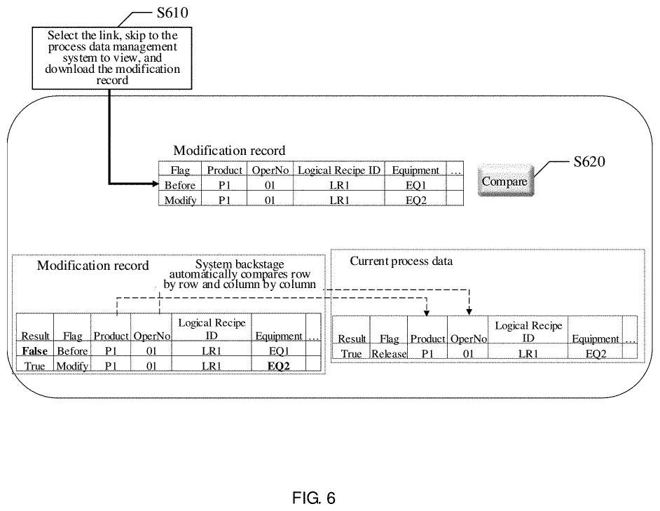

According to the storage information of the current process data, the current process data may be acquired from the corresponding data management system, for example, the data management system may be entered through a corresponding web address, and the current process data may be searched according to the index information of the process data. After the current process data is acquired, the current process data may be further compared with the above-mentioned modification record, so as to obtain the comparison result of the two. Referring to FIG. 6, the user or form review personnel may enter the process data management system through the link to acquire the modification record through step S610, and select the “Compare” option to obtain the current process data through step S620, so as to compare the modification record with the current process data.

In an optional embodiment, the modification record may include process data before modification and process data after modification.

In an optional embodiment, the comparison result may include whether the process data before modification is consistent with the current process data, and whether the process data after modification is consistent with the current process data.

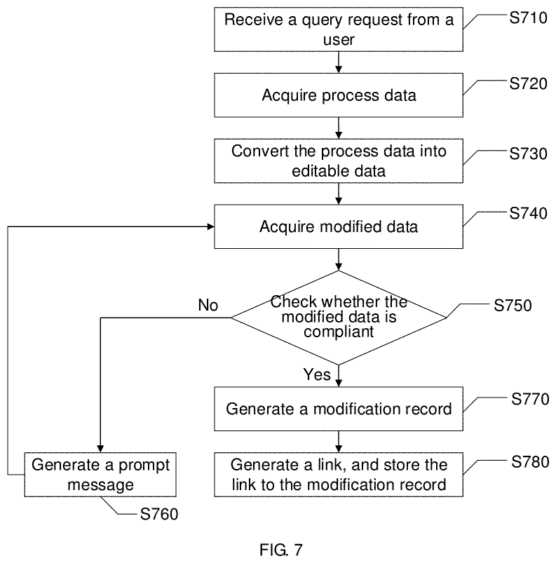

FIG. 7 shows a modification process of process data. Specifically, the modification process may include steps S710 to S780 below:

Step S710. A query request is received from a user. The query request may include query information of process data that is inputted by the user, for example, the query information may include data such as product number, route number and operation step.

Step S720. Process data is acquired.

According to the index information of the process data, the corresponding process data may be acquired from the process data management system.

Step S730. The process data is converted into editable data.

Step S740. Modified data for the editable data is received in response to user's modification operation on the editable data.

Step S750. Whether the modified data is compliant is checked; when it is determined that the modified data is not compliant, step S760 is executed to generate a prompt message indicating that the modified data is not compliant; when it is determined that the modified data is compliant, step S770 is executed to generate a modification record according to the modified data.

After the prompt message indicating that the modified data is not compliant is generated, modified data generated after the user edits the editable data may be continuously received through step S740.

Step S760. A prompt message indicating that the modified data is not compliant is generated.

The prompt message may be a message pop-up window, may include information that the modified data is not compliant, and may also include specific data records that are not compliant in the modified data.

Step S770. A modification record is generated according to the modified data.

When the modification record is generated, the corresponding modification position in the modification record may also be marked.

Step S780. A link for the modification record is generated, and the link is stored in the modification record.

By generating the link for the modification record, the corresponding modification record can be quickly located for the user to view and further operate when a user's access request for the link is received.

Further, because standard process data is used on a production line, that is, the current process data may change with the production process, in order to ensure the correctness of the current process data, in an optional embodiment, current process data at the current moment may be acquired after the process data is modified by the above method and the modification record is generated, and the current process data and the modification record stored in the system, that is, the process change demand record, are checked and compared.

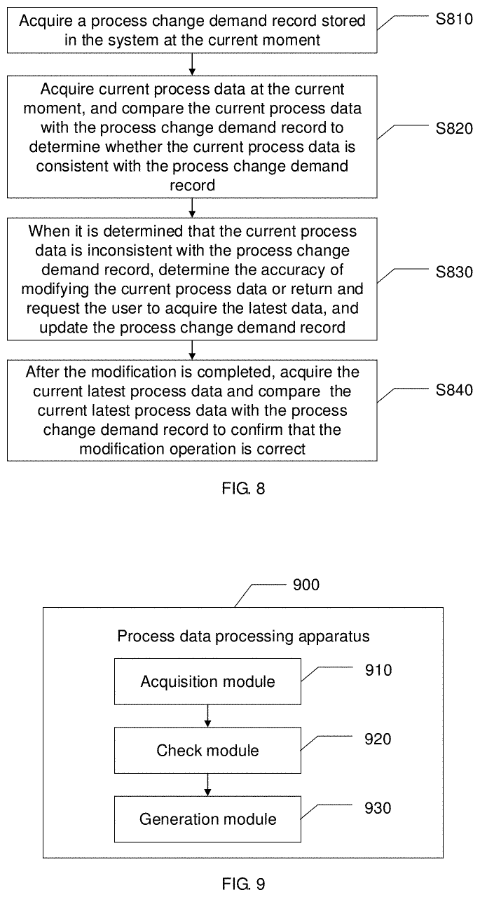

FIG. 8 shows a comparison process of current process data. Specifically, the comparison process may include the following steps S810 to S840:

Step S810. A process change demand record stored in the system at the current moment is acquired.

The process change demand record refers to a modification record generated by the user modifying the process data in the past time, and usually may be a modification record generated by the user modifying the process data last time.

Specifically, the user may acquire the corresponding process change demand record by selecting the link for the process change demand record.

Step S820. Current process data at the current moment is acquired, and the current process data is compared with the process change demand record to determine whether the current process data is consistent with the process change demand record.

Specifically, the user may select the “Query” option in the system interface to acquire the current process data stored in the system at the current moment, and select the “Compare” option to compare the acquired current process data with the process change demand record.

When it is determined that the current process data is completely consistent with the data in the process change demand record, a prompt message such as “Comparison complete, data consistent” may be generated; correspondingly, when it is determined that the current process data is inconsistent with the data in the process change demand record, a prompt message such as “Comparison complete, data inconsistent” may be generated to remind the user to modify the current process data.

Step S830. When it is determined that the current process data is inconsistent with the process change demand record, the accuracy of modifying the current process data is determined or return and the user is requested to acquire the latest data, and the process change demand record is updated.

For example, when it is determined that there is one or more inconsistencies between the current process data and the data in the process change demand record, the inconsistent data record may be marked so that the user can modify the current process data.

Step S840. After the modification is completed, the current latest process data is acquired and compared with the process change demand record to confirm that the modification operation is correct.

After the modification is completed, the current process data stored in the system may be acquired in real time, and the current process data may be compared with the process change demand record again, until the current process data stored in the system is consistent with the process change demand record generated last time.

By modifying the current process data, the correctness of the standard process data used on the production line can be ensured, and accordingly, the data management efficiency can also be improved.

Based on the above, according to the method for processing process data in this exemplary embodiment, modified data for process data is acquired, whether the modified data is compliant is checked according to the fields of the modified data, and a modification record is generated according to the modified data when it is determined that the modified data is compliant. On the one hand, by acquiring the modified data for the process data, the data that has been modified by the user can be quickly filtered out of the process data, which can reduce the time for the user to determine the modified data and improve the efficiency of data check; on the other hand, by checking the compliance of the modified data, the wrong data in the modified data can be effectively located, a basis is provided for the user to further modify the data, the error rate of modifying the data is reduced, and the method has great significance for reducing production cost; on the other hand, by generating the modification record, the modification information after each modification by the user can be stored, which helps the user to determine the modification of the process data, and provides a data support for the management of data, production, etc.

Further, this exemplary embodiment also provides a process data processing apparatus. As shown in FIG. 9, the process data processing apparatus 900 may include: an acquisition module 910, which may be configured to acquire modified data for process data; a check module 920, which may be configured to check whether the modified data is compliant according to the fields of the modified data; and a generation module 930, which may be configured to generate a modification record according to the modified data when it is determined that the modified data is compliant.

In an exemplary embodiment of the present disclosure, the acquisition module 910 may be configured to provide editable data of the process data in response to a user's query request for the process data, and receive the modified data for the editable data.

In an exemplary embodiment of the present disclosure, the acquisition module 910 may be further configured to receive the modified data in response to an editing completion operation on the editable data.

In an exemplary embodiment of the present disclosure, the editable data may include preset fields of the process data, wherein the preset fields may include any one or more of equipment group, equipment, recipe, recipe version, available reaction chamber for the recipe, unavailable reaction chamber, whether the operation equipment selects different recipe identification according to different reaction chambers, sampling policy, number of samples, monitor product identification, whether to wait for complete measurement of the monitor product, probe fixture group, whether recipe parameter identification is set at an operation step, etc.

In an exemplary embodiment of the present disclosure, the check module 920 may be configured to determine the fields of the modified data, obtain a preset modification rule for each field, and check whether the corresponding data in the fields of the modified data is compliant under the preset modification rule.

In an exemplary embodiment of the present disclosure, the preset modification rule may include any one or more of the following: a value allowed to be set in the field; data in the field being a preset format; no repeated data in the field; no empty value in the field; no special character in the field; data in the field being any one of the preset values; an associated setting rule for data in two fields at least; and whether the data in the field is consistent with the pre-stored data.

In an exemplary embodiment of the present disclosure, when checking whether the modified data is compliant, the check module 920 may further be configured to generate a prompt message about the modified data when it is determined that the modified data is not compliant.

In an exemplary embodiment of the present disclosure, when generating a modification record according to the modified data, the generation module 930 may be configured to mark a modification position corresponding to the modified data in the modification record.

In an exemplary embodiment of the present disclosure, when generating the modification record according to the modified data, the generation module 930 may further be configured to generate a link for the modification record, and provide the modification record in response to a user's operation of selecting the link.

In an exemplary embodiment of the present disclosure, the acquisition module 910 may further be configured to acquire current process data, and compare the current process data with the modification record and obtain a comparison result.

In an exemplary embodiment of the present disclosure, the modification record may include process data before modification and process data after modification.

In an exemplary embodiment of the present disclosure, the comparison result may include: whether the process data before modification is consistent with the current process data, and whether the process data after modification is consistent with the current process data.

In an exemplary embodiment of the present disclosure, before acquiring the modified data for the process data, the acquisition module 910 may also be configured to display preview data of the process data in response to a user's query request for the process data.

The specific details of various modules in the above apparatus are described in detail in the embodiment of the method. The undisclosed details may refer to the embodiment of the method, and will not be repeated.

It could be appreciated by those skilled in the art that various aspects of the present disclosure may be implemented as systems, methods, or program products. Therefore, the various aspects of the present disclosure may be implemented in the following forms: complete hardware implementations, complete software implementations (including firmware, microcodes, etc.), or combined implementations of hardware and software, which may be collectively referred to as “circuits”, “modules”, or “systems” herein.

An exemplary embodiment of the present disclosure further provides a computer-readable storage medium, storing a program product capable of implementing the above-mentioned method in this specification. In some possible implementations, various aspects of the present disclosure may also be implemented in the form of a program product, which includes program codes. When the program product runs on a terminal equipment, the program codes are used to enable the terminal equipment to execute the steps according to various exemplary embodiments of the present disclosure described in the “exemplary method” section of this specification.

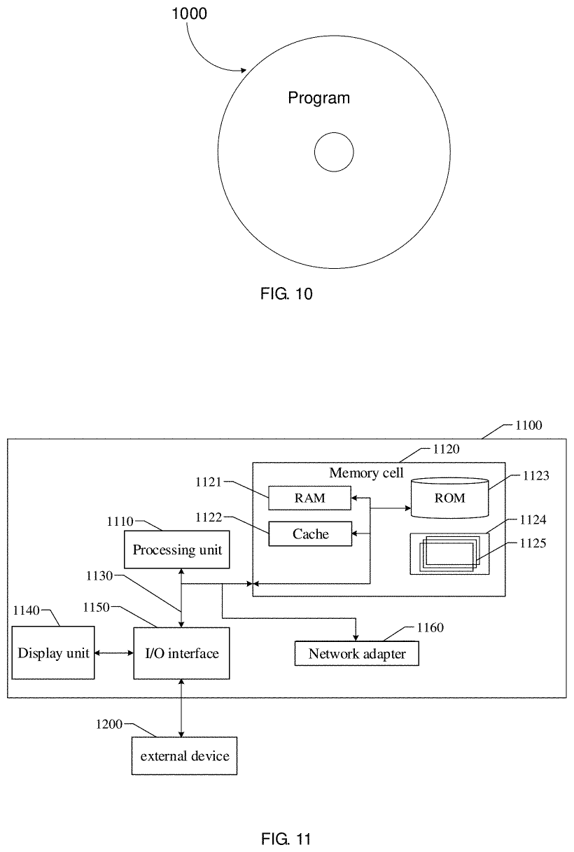

Referring to FIG. 10, a program product 1000 according to an exemplary embodiment of the present disclosure for implementing the above method is described. The program product may be a portable compact disk read-only memory (CD-ROM), includes program codes, and may be run on a terminal equipment, for example, a personal computer. However, the program product of the present disclosure is not limited to this. Herein, the readable storage medium may be any tangible medium that includes or stores a program, and the program may be used by or combined with an instruction execution system, apparatus or device.

The program product 1000 may adopt a readable medium or any combination of more readable media. The readable medium may be a readable signal medium or a readable storage medium. An example of the readable storage medium may be, but is not limited to electric, magnetic, optical, electromagnetic, infrared, or semiconductor systems, apparatuses or devices, or any combination of the above. A more specific example (a non-exhaustive list) of the readable storage medium may include: an electrical connection with one or more wires, a portable disk, a hard disk, a random access memory (RAM), a read-only memory (ROM), an erasable programmable read-only memory (EPROM or flash memory), a fiber, a portable compact disk read-only memory (CD-ROM), an optical memory, a magnetic memory, or any suitable combination of the above.

The computer-readable signal medium may include data signals in a baseband or propagated as part of carriers, in which readable program codes are carried. The propagated data signals may be in various forms, including but not limited to electromagnetic signals, optical signals or any suitable combination thereof. The readable signal medium may also be any readable medium beyond the readable storage media. The readable medium is capable of sending, propagating or transmitting a program used by or in combination with an instruction execution system, apparatus or device.

The program codes included in the readable medium may be transmitted by any appropriate medium, including but not limited to wireless, wired, optical cable, RF, etc., or any appropriate combination of the above.

Program codes for executing operations of the present disclosure may be compiled in one or more programming languages. The programming languages include object-oriented programming languages, such as Java and C++, and also include conventional procedural programming languages, such as “C” language or similar programming languages. The program codes may be completely executed on a user's computing device, partially executed on a user's device, executed as a separate software package, partially executed on a user's computing device and partially executed on a remote computing device, or completely executed on a remote computing device or server. In the circumstance involving a remote computing device, the remote computing device may be connected to a user's computing device over any type of network, including a local area network (LAN) or wide area network (WAN), or may be connected to an external computing device (for example, connected over the Internet by means of an Internet service provider).

An exemplary embodiment of the present disclosure further provides an electronic equipment capable of implementing the above method. The electronic equipment 1100 according to this exemplary embodiment of the present disclosure will be described below with reference to FIG. 11. The electronic equipment 1100 shown in FIG. 11 is just an example, which does not impose any restrictions on the functions and scope of application of the embodiments of the present disclosure.

As shown in FIG. 11, the electronic equipment 1100 may be represented in the form of a general-purpose computing device. The components of the electronic equipment 1100 may include, but are not limited to: the aforementioned at least one processing unit 1110, the aforementioned at least one memory cell 1120, a bus 1130 connecting different system components (including the memory cell 1120 and the processing unit 1110), and a display unit 1140.

The memory cell 1120 stores program codes, and the program codes may be executed by the processing unit 1110, so that the processing unit 1110 performs the steps according to various exemplary implementations of the present disclosure described in the “exemplary method” section of the specification. For example, the processing unit 1110 may execute the method steps shown in FIGS. 1, 4, and 6 to 8.

The memory cell 1120 may include a readable medium in the form of a volatile memory unit, such as a random access memory (RAM) 1121 and/or a cache 1122, and may further include a read-only memory (ROM) 1123.

The memory cell 1120 may also include a program/utility tool 1124 having a set (at least one) of program modules 1125, such program module 1125 including, but not limited to an operating system, one or more applications, other program modules, and program data. Each one or a combination of these examples may include the implementation of a network environment.

The bus 1130 may represent one or more of several types of bus structures, including a memory unit bus or memory unit controller, a peripheral bus, a graphics acceleration port, a processing unit, or a local area bus using any of a variety of bus structures.

The electronic equipment 1100 may also communicate with one or more external devices 1200 (e.g., a keyboard, a pointing device, a Bluetooth device, etc.), and may also communicate with one or more devices that enable a user to interact with the electronic equipment 1100, and/or communicate with any device (e.g., a router, a modem, etc.) that enables the electronic equipment 1100 to communicate with one or more other computing devices. The communication may be performed via an input/output (I/O) interface 1150. In addition, the electronic equipment 1100 may also communicate with one or more networks (for example, a local area network (LAN), a wide area network (WAN), and/or a public network, such as the Internet) via a network adapter 1160. As shown in the figure, the network adapter 1160 communicates with other modules of the electronic equipment 1100 via the bus 1130. It should be understood that although not shown in the figure, other hardware and/or software modules may be used in combination with the electronic equipment 1100, including but not limited to: microcodes, a device driver, a redundant processing unit, an external disk drive array, an RAID system, a tape driver, a data backup storage system, etc.

It should be noted that, although a number of modules or units of the apparatus for operation are mentioned in the above detailed description, this division is not mandatory. In fact, according to the exemplary embodiments of the present disclosure, the features and functions of two or more modules or units described above may be embodied in one module or unit. Conversely, the features and functions of a module or unit described above may be further divided into multiple modules or units to be embodied.

In addition, the above drawings are merely schematic illustrations of the processes included in the method according to the exemplary embodiments of the present disclosure, and are not intended for limitation. It is easy to understand that the processes shown in the above drawings do not indicate or limit the time sequence of the processes. In addition, it is also easy to understand that these processes may be executed synchronously or asynchronously in multiple modules, for example.

Through the description of the above embodiments, those skilled in the art can easily understand that the exemplary embodiments described here can be implemented by software, or can be implemented by combining software with necessary hardware. Therefore, the technical solution according to the exemplary embodiments of the present disclosure may be embodied in the form of a software product, and the software product may be stored in a non-volatile storage medium (which may be a CD-ROM, a U disk, a mobile hard disk, etc.) or on the network, and includes instructions enabling a computing device (which may be a personal computer, a server, a terminal device, or a network device, etc.) to execute the method according to the exemplary embodiments of the present disclosure.

The present disclosure is described with reference to the flowcharts and/or block diagrams of the method, the apparatus (device), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, such that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, such that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, such that a series of operations and steps are performed on the computer or the another programmable device, thereby generating computer-implemented processing. Therefore, the instructions executed on the computer or the another programmable device provide steps for implementing a function specified in one or more processes in the flowcharts and/or in one or more blocks in the block diagrams.

A person skilled in the art would readily conceive of other embodiments of the present disclosure after considering the specification and practicing the invention disclosed herein. The present application is intended to cover any variations, uses or adaptive changes of the present disclosure. These variations, uses or adaptive changes follow the general principle of the present disclosure and include common general knowledge or conventional technical means in the technical field that are not disclosed in the present disclosure. The description and the embodiments are only regarded as exemplary, and the true scope and spirit of the present disclosure are indicated by the claims.

1. A method for processing process data, the method comprising:
acquiring modified data for process data;
checking whether the modified data is compliant according to fields of the modified data; and
generating a modification record according to the modified data when it is determined that the modified data is compliant.

2. The method for processing process data according to claim 1, wherein the acquiring modified data for process data comprises:
providing editable data of the process data in response to a user's query request for the process data; and
receiving the modified data for the editable data.

3. The method for processing process data according to claim 2, wherein the receiving the modified data for the editable data comprises:
receiving the modified data in response to an editing completion operation on the editable data.

4. The method for processing process data according to claim 2, wherein the editable data comprises preset fields of the process data, wherein the preset fields comprise any one or more of equipment group, equipment, recipe, recipe version, available reaction chamber for the recipe, unavailable reaction chamber, whether operation equipment selects different recipe identification according to different reaction chambers, sampling policy, number of samples, monitor product identification, whether to wait for complete measurement of a monitor product, probe fixture group, whether recipe parameter identification is set at an operation step.

5. The method for processing process data according to claim 1, wherein the checking whether the modified data is compliant comprises:
determining the fields of the modified data;
obtaining a preset modification rule for each field; and
checking whether corresponding data in the fields of the modified data is compliant under the preset modification rule.

6. The method for processing process data according to claim 5, wherein the preset modification rule comprises any one or more of the following:
a value allowed to be set in the field;
data in the field being a preset format;
no repeated data in the field;
no empty value in the field;
no special character in the field;
data in the field being any one of preset values;
an associated setting rule for data in two fields at least; and
whether the data in the field is consistent with pre-stored data.

7. The method for processing process data according to claim 1, when checking whether the modified data is compliant, the method further comprises:
generating a prompt message about the modified data when it is determined that the modified data is not compliant.

8. The method for processing process data according to claim 1, when generating a modification record according to the modified data, the method further comprises:
marking a modification position corresponding to the modified data in the modification record.

9. The method for processing process data according to claim 1, when generating a modification record according to the modified data, the method further comprises:
generating a link for the modification record; and
providing the modification record in response to a user's operation of selecting the link.

10. The method for processing process data according to claim 1, further comprising:
acquiring current process data, and comparing the current process data with the modification record and obtaining a comparison result.

11. The method for processing process data according to claim 10, wherein the modification record comprises process data before modification and process data after modification.

12. The method for processing process data according to claim 10, wherein the comparison result comprises: whether the process data before modification is consistent with the current process data, and whether the process data after modification is consistent with the current process data.

13. The method for processing process data according to claim 1, before acquiring the modified data for the process data, the method further comprises:
displaying preview data of the process data in response to a user's query request for the process data.

14. A process data processing apparatus, the process data processing apparatus comprising:
one or more processors; and
a storage apparatus, configured to store one or more programs, wherein the one or more programs, when executed by the one or more processors, cause the one or more processors to execute operations of:
acquiring modified data for process data;
checking whether the modified data is compliant according to fields of the modified data; and
generating a modification record according to the modified data when it is determined that the modified data is compliant.

15. A computer-readable storage medium, storing a computer program thereon, wherein when the computer program is executed by a processor, the method according to claim 1 is implemented.
